(19) United States
(12) Patent Application Publication
(10) Pub. No.: US 2007/0008842 A1
(43) Pub. Date: Jan. 11, 2007

(54) Optical disk device

(75) Inventors: Nobuyuki Baba, Kawasaki-city (JP); Yuuichi Nakamura, Kawasaki-city (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Toshiba Samsung Storage Technology Corporation, Kawasaki-city (JP)

(21) Appl. No.: 11/480,916

(22) Filed: Jul. 6, 2006

(30) Foreign Application Priority Data
Jul. 7, 2005 (JP) 2005-198889

(51) Int. Cl. G11B 5/09

(52) U.S. Cl. 369/47.1

(57) ABSTRACT

According to an optical disk device of the present invention, in the drive operation, when a detection circuit detects an electric wave coming from an outside radio equipment, and a comparison circuit detects that the voltage of the electric wave is equal to or over a predetermined threshold level, in case it is determined that data is being reproduced from or data is being recorded to a record type medium, a CPU controls a laser drive circuit to temporarily turn off the output of laser from an optical PUH. On the other hand, in case it is determined that data is being reproduced from a read type medium, the CPU controls the laser drive circuit to enhance the power of laser of the optical PUH to improve the S/N ratio.

### CROSS-REFERENCE TO RELATED APPLICATIONS

This application is based upon and claims the benefit of priority from the prior Japanese Patent Applications No. 2005-198889, filed on Jul. 7^{th}, 2005; the entire contents of which are incorporated herein by reference.

### BACKGROUND OF THE INVENTION

1. Field of the Invention

The present invention relates to an optical disk device, and more particularly, to an optical disk device that, when coming under the influence of electric waves generated at outside at the time of reproducing data from or recording data to an optical disk, can detect and deal with the electric waves.

2. Description of the Related Art

Electronic devices are, in case no countermeasure is taken, sometimes subject to lowering of function, malfunction, shutoff of operation, loss of recorded data, etc. due to the influence of radiated electromagnetic waves coming from other nearby apparatuses. Especially, electromagnetic waves radiated from radio equipments sometimes exercise an influence such as resonance on other electronic devices. Various researches are carried on for the countermeasure against radio frequency interference and immunity.

For example, as an electronic device that is used with a portable storage medium attached thereto, there is proposed one that has a portable storage medium whose metal plate of the insertion surface is so shaped or configured as not to resonate with an electric wave coming from a cellular phone located outside, etc. (for example, Jpn. Pat. Appln. Laid-Open Publication No. 2001-67851).

That is, with respect to an electric wave coming from a cellular phone, so as to make a configuration of disaccording with half the wavelength “λ” of the electric wave or integral multiple thereof, the wavelength “λ,” becomes as follows in case the frequency “f” of an electric wave coming from outside is 1.5 GHz.
λ=speed of light (3×10⁸)/frequency of cellular phone (1.5×10⁹)=0.2 m (20 cm)
Accordingly, in case the dimension of the insertion surface of a portable storage medium is set to a value of 10 cm, this value undesirably accords with half the wavelength “λ,” of the frequency “f”. Thus, so as to make a configuration of disaccording with half the wavelength “λ” or integral multiple thereof, for example, the dimension of the insertion surface of a portable storage medium is set to a value of 11 cm.

In above-described conventional technique, for example, it is assumed that the frequency “f” of an electric wave coming from an outside cellular phone is 1.5 GHz, and the dimension of the front opening section of an optical disk device or an image forming device which uses a portable storage medium, that is, the insertion surface of a portable storage medium is determined such that the resonance point of an electric wave coming from a cellular phone located outside and an internal electric wave is made to shift.

On the other hand, even if a housing of an optical disk device is so configured as not to resonate, in reality, an electric wave directly coming from the opening section may have a bad effect. Otherwise, an electric wave may infiltrate into an internal electronic circuit from a housing itself of an optical disk device through ground to have a bad effect.

Furthermore, with respect to frequency bands of currently used cellular phones, even if a housing of an optical disk device is so designed as not to accord with ½λ, ¼λ, . . . , this configuration will not be assured in the future. That is, it is anticipated that cellular phones will be further improved and use high frequency bands, and that an electric wave will easily infiltrate from the opening section of a housing of an optical disk device.

Moreover, in reality, since cellular phones are used not in the frequency band of 800 MHz or 1.5 GHz, but in a frequency band near the values, and an electric wave is modulated in diverse ways. Accordingly, it is difficult to realize a configuration in which the housing of an optical disk device does not resonate.

### BRIEF SUMMARY OF THE INVENTION

According to an aspect of the present invention, there is provided an optical disk device that detects an electric wave coming from a radio equipment located outside to determine whether or not the frequency thereof will actually have a bad effect, and can deal with the electric wave depending on the configuration of the optical disk device.

The present invention may provide an optical disk device, comprising: a drawer to which a mechanical chassis is placed, the mechanical chassis having mounted thereto a drive mechanism for supporting and rotating a portable information recording medium, an optical pickup, a laser drive circuit for driving the optical pickup, a servo drive circuit, and an electronic circuit; an antenna that is placed in the vicinity of an opening of a device main body at which the drawer is arranged; a detection unit that detects an electric wave radiated from an outside radio equipment using the antenna; and a control unit that, when the detection unit detects an electric wave of a frequency band that has a fear of bringing about malfunction, controls to prevent malfunction in the recording or reproduction operation for the portable information recording medium.

### BRIEF DESCRIPTION OF THE DRAWINGS

FIG. 1 shows a block diagram indicative of the configuration of an optical disk device according to an embodiment of the present invention;

FIG. 2 shows a block diagram indicative of the configuration of a detection circuit unit shown in FIG. 1;

FIG. 3 shows a flowchart indicative of the performance of the optical disk device according to an embodiment of the present invention;

FIG. 4 shows a schematic view indicative of the state in which a drawer is drawn from the optical disk device;

FIG. 5 shows a schematic view indicative of the figuration of an opening A shown in FIG. 4; and

FIG. 6 shows arrangement examples of a bezel and an antenna of the optical disk device according to an embodiment of the present invention.

### DETAILED DESCRIPTION OF THE INVENTION

The present invention will further be described below with reference to the accompanying drawings. In the respective drawings, similar parts or components are indicated with the same reference numerals, and detailed explanation of which will be omitted.

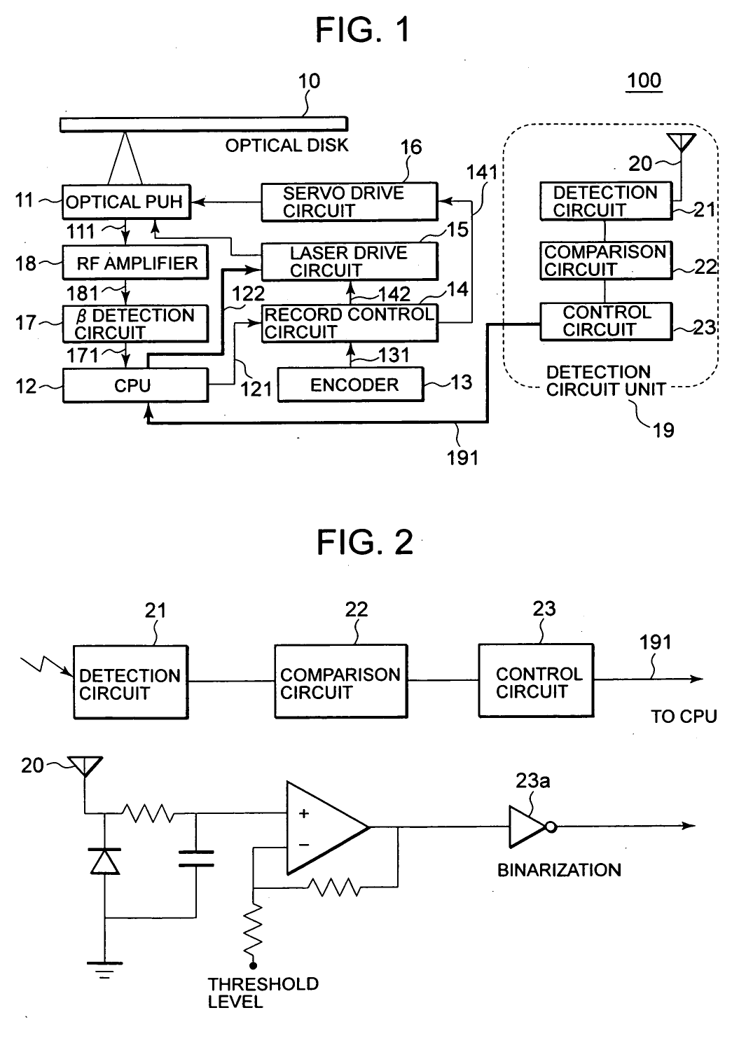

FIG. 1 shows a block diagram indicative of the configuration of an optical disk device 100 according to an embodiment of the present invention. As shown in FIG. 1, the optical disk device 100 includes an optical pickup head (referred to as an optical PUH, hereinafter) 11 that irradiates a laser beam to an optical disk 10 being a portable information recording medium, a CPU 12, an encoder 13 that EFM-modulates information to be recorded to the optical disk 10, a record control circuit 14 that outputs a control signal to control the recording operation for the optical disk 10, a laser drive circuit 15 that drives the optical PUH 11, a servo drive circuit 16 that determines the position of the optical PUH 11, a β detection circuit 17, an RF amplifier 18 that amplifies an RF signal, a detection circuit unit 19, etc.

The encoder 13 EFM-modulates information to be recorded to the optical disk 10, and outputs thus modulated data. The EFM modulation is a modulation method using a conversion table, which converts 8-bit data to 14-bit data, and converts patterns including successive “1” data to patterns including “0” to record thus modulated data.

Then, an EFM signal 131 from the encoder 13 and a control signal 121 from the CPU 12 are sent to the record control circuit 14. The record control circuit 14 outputs drive control signals 141 and 142 to the servo drive circuit 16 and the laser drive circuit 15, respectively. The servo drive circuit 16 sets the optical PUH 11 to the appropriate position. The laser drive circuit 15 applies a current to a laser diode of the optical PUH 11 based on the drive control signal 142, and makes the laser diode irradiate a laser beam to the optical disk 10. A reflected light from the optical disk 10 is received by the optical PUH 11, and the optical PUH 11 outputs an RF signal 111 corresponding to the reflected light to the RF amplifier 18. The RF amplifier 18 amplifies the RF signal 181, and outputs thus amplified RF signal 181 to the β detection circuit 17. The β detection circuit 17 measures the peak value, or the top A value and the bottom B value, of thus received amplified RF signal 181, and outputs a β signal 171, which is calculated using mathematical formula (1), to the CPU 12.
β=(A+B)/(A−B) (1)
The CPU 12 obtains a laser power that makes the β value most suitable based on the β signal 171, and outputs control signals 121 and 122 designating correction to the record control circuit 14 and the laser drive circuit 15, respectively. Then, data is recorded to the optical disk 10 using thus obtained laser power making the β value most suitable.

In case an electric wave radiated from an outside radio equipment comes into the optical disk device 100 when in operation, sometimes noises are brought about in signals at the time of reproducing recorded data, which prevents the recorded data from being reproduced. Furthermore, when data recorded on a record type disk is reproduced, in case the laser drive circuit 15 is adversely affected by an infiltrating electric wave, there is raised a fear that a record power is output even at the time of reproduction operation, thereby damaging data. Similarly, when recording data, there is raised a fear that recording operation is not suitably carried out.

In order to avoid such most undesirable situation, the optical disk device according to the present invention detects the frequency of an electric wave that comes into or infiltrates into an electronic circuit (drive) to have a bad effect thereon, and, for example, at the time of reproducing data recorded on a read type disk (ROM), enhances the power of laser to improve the S/N ratio so as to prevent malfunction. Furthermore, for example, at the time of reproducing data from or recording data to a record type disk, the output of laser is turned off so as to prevent malfunction.

Next, the detection circuit unit 19 shown in FIG. 1 will be explained. The upper drawing in FIG. 2 shows a block diagram indicative of the configuration of the detection circuit unit 19. On the other hand, the lower drawing in FIG. 2 shows the specific configuration of respective circuits.

The detection circuit unit 19 includes an antenna 20, a detection circuit 21, a comparison circuit 22, and a control circuit 23. The detection circuit 21 detects the frequency of an electric wave sent from the antenna 20. Then, the comparison circuit 22 compares the voltage of the electric wave with a threshold level of voltage to be dealt with. Then, in case it is detected that the voltage of the electric wave is equal to or over the threshold level and there is a fear that the electric wave is of a frequency band that may bring about malfunction in the optical disk device, the control circuit 23 makes its digital inverter 23a binarize the comparison output, and sends thus obtained binarized signal 191 to the CPU 12. The CPU 12 controls the laser drive circuit 15 using the binarized signal 191 to operate the optical disk device 100, preventing malfunction.

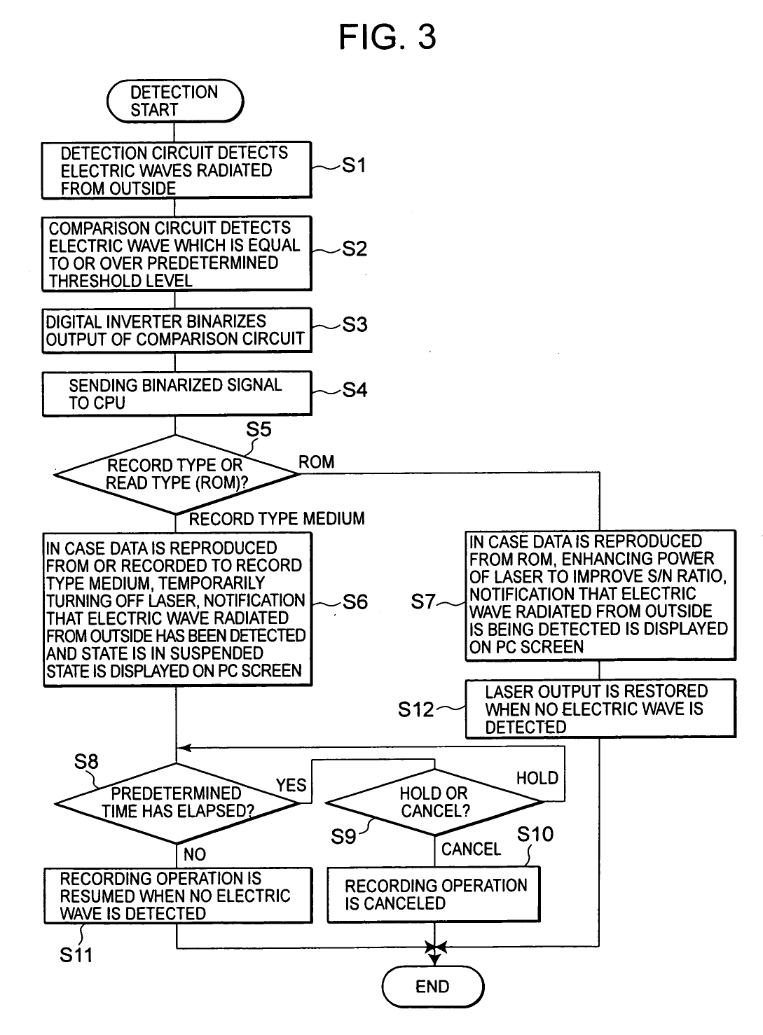

Next, the performance of the optical disk device according to the present invention will be explained with reference to a flowchart shown in FIG. 3.

Firstly, when the optical disk device 100 is driven to be operated, the detection circuit 21 detects electric waves radiated from nearby outside radio equipments (step S1).

Next, the comparison circuit 22 detects an electric wave whose voltage is equal to or over a predetermined threshold level (step S2). The threshold level is set to a level that brings about malfunction in the optical disk device 100.

Then, the digital inverter 23a binarizes the output of the comparison circuit 22 (step S3), and the control circuit 23 sends the binarized signal 191 to the CPU 12 (step S4).

At this time, the CPU 12 discriminates the relation between the laser drive circuit 15 and the optical disk 10 (step S5), and carries out operation control to prevent malfunction depending on the configuration of medium.

That is, in step S5, in case it is determined that the optical disk 10 is a record type medium and the laser drive circuit 15 is reproducing data from or recording data to the record type medium, the CPU 12 temporarily suspends the operation of the laser drive circuit 15, and temporarily turns off the output of laser from the optical PUH 11. Then, a notification that an electric wave radiated from an outside radio equipment has been detected and the optical disk device 100 is in the suspended state is displayed on a PC screen, not shown (step S6). In addition to displaying the notification on the PC screen, a status LED may be blinked under the timing for detecting an electric wave so as to notify the user of the suspended state.

Next, it is checked whether or not a predetermined time has elapsed (step S8). In case an electric wave is continuously detected after the predetermined time (step S8, Yes), a notification that an electric wave is detected again is displayed on a PC screen, not shown. Then, the user confirms the notification displayed on the PC screen, and, when in the recording operation, selects either continuing the hold state or canceling the recording operation, and enters the determination (step S9). In case continuing the hold state is selected, the processing returns to step S8. Then, the recording operation is resumed when no electric wave is detected (step S11). On the other hand, in case an electric wave is detected after a predetermined time has elapsed, selection in step S9 is resumed. Then, in case canceling the recording operation is selected, the recording operation is canceled (step S10). In case of canceling the recording operation, it is a user-friendly and desirable response to give a warning by displaying a notification that the disk becomes unusable on a PC screen.

On the other hand, in step S5, in case it is determined that the optical disk 10 is a read type medium (ROM disk) and the laser drive circuit 15 is reproducing data from the ROM disk, the CPU 12 enhances the power of laser of the optical PUH 11 through the laser drive circuit 15 to improve the S/N ratio. Concurrently, a notification that an electric wave radiated from an outside radio equipment is being detected is displayed on a PC screen, not shown (step S7). Then, when no electric wave is detected, the CPU 12 restores the output of laser of the optical PUH 11 through the laser drive circuit 15 to record data (step S12).

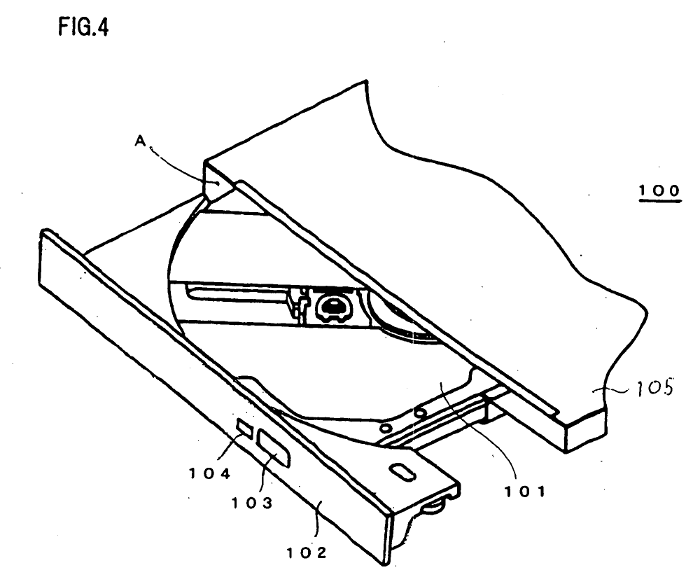

Next, setting of the antenna 20 of the detection circuit unit 19 that detects the frequency of an electric wave having a bad effect will be explained with reference to FIG. 4 to FIG. 6.

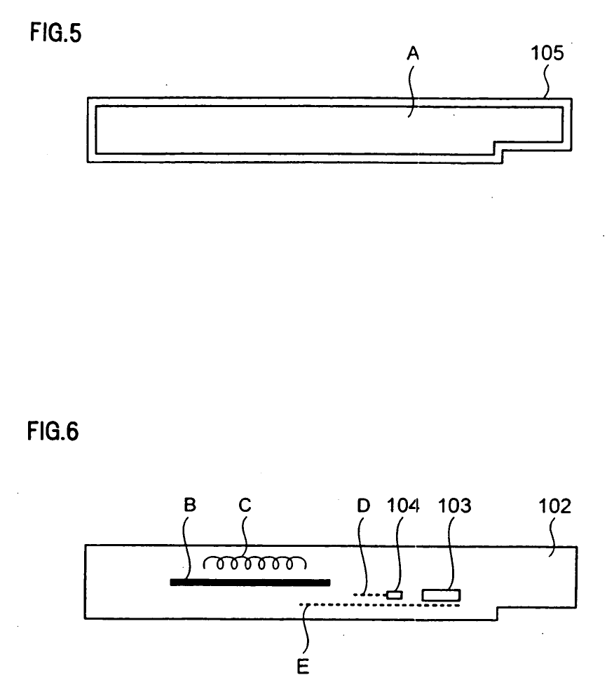

FIG. 4 shows a schematic view indicative of the state in which a drawer 101 is drawn from the optical disk device 100. FIG. 5 shows a schematic view indicating an opening A. At the opening A formed inside a main body housing 105 of the optical disk device 100, there is slidably arranged the drawer 101 to which a mechanical chassis is placed, which mechanical chassis has mounted thereto a drive mechanism for supporting and rotating the optical disk 10 being a portable information recording medium, the optical PUH 11, a drive mechanism for driving the optical PUH 11, and an electronic circuit.

It is difficult to set the dimension of the opening A in the longitudinal direction so that the main body housing 105 does not resonate with an electric wave coming from a currently used cellular phone or an electric wave of a higher frequency band which is expected to be used in the future. Accordingly, an electric wave coming from an outside radio equipment easily infiltrates into the inside of the drawer 101 from the opening A to have a bad effect on an electronic circuit of the drawer 101.

Thus, according to the present invention, an electric wave coming from an outside radio equipment is surely detected, and in case the level of the electric wave has a bad effect, a countermeasure corresponding to step S5 or step S7 of FIG. 3 is taken. Accordingly, the antenna mechanism to surely detect the infiltrating electric wave is very important.

FIG. 6 shows the configuration of the antenna 20 installed to a bezel 102 of the optical disk device according to the present invention.

It is desired that the antenna 20 in the detection circuit unit 19 be located at a position where an electronic circuit of the optical disk device 100 is adversely affected easily by an electric wave coming from an outside radio equipment and the electric wave from the outside radio equipment is easily detected. Therefore, the antenna 20 is arranged at the inside surface or outside surface of the bezel 102 that is arranged at the front surface of the drawer 101 located in the vicinity of the opening A formed inside the main body housing 105 of the optical disk device 100 (antenna B shown in FIG. 6).

Otherwise, the antenna 20 is embedded into the inside of the bezel 102 (antenna C shown in FIG. 6).

Otherwise, a flexible wiring of an LED 104 for displaying status arranged inside the opening A of the optical disk device 100 is made to work as an antenna (antenna D shown in FIG. 6).

Otherwise, a wiring of an ejector button 103 is made to work as an antenna (antenna E shown in FIG. 6).

Otherwise, a static electricity lead-in tag is made to work as an antenna.

Since the bezel 102 is made of resin and an electric wave coming from an outside radio equipment can be detected through the bezel 102, there is raised no disadvantage in detecting an electric wave even if the antenna 20 is arranged in the internal vicinity of the opening A, as the cases of the respective examples (antenna B to antenna E).

As the vicinity of the opening A of the optical disk device 100, the antenna 20 may be arranged at the main body housing 105 which is the outer circumference of the opening A. In this case, when the main body housing 105 is made of resin, the antenna 20 can be arranged at the inside surface or outside surface of the main body housing 105.

Furthermore, in case the main body housing 105 of the optical disk device 100 is housed in a case to be used as an external device of such as a personal computer, the antenna 20 can be arranged in the vicinity of an opening of the case for the external device.

The antenna 20 may be a rod antenna, a helical whip antenna, etc., and the shape which can easily detect an electric wave coming from a cellular phone is desirable.

In case an electric wave coming from an outside radio equipment is detected, the LED 104 for displaying status may be blinked to notify the user of the optical disk device 100 of the detection so as to urge the user to perform above-described operation.

As an application example of the detection circuit unit 19, an electric wave coming from an outside radio equipment enables radio operation. For example, a special performance command for maintenance and a special command for changing part of firmware are prepared in advance, and a host side such as a personal computer, a recorder, a remote control, etc. outputs a radio signal corresponding to the special command. By receiving the radio signal utilizing an antenna, performance corresponding to the special command is carried out. Furthermore, by dealing with the radio signal transmitted from the host side as data, difference addition of firmware can be performed.

According to an embodiment of the present invention, it becomes possible to provide an optical disk device that detects an electric wave coming from an outside radio equipment to determine whether or not the frequency thereof will have a bad effect, and can deal with the electric wave depending on the configuration of the optical disk device.

While the invention has been described in accordance with certain preferred embodiments, it should be understood that the invention is not limited to the embodiments, but various modifications, alternative constructions or equivalents can be implemented without departing from the scope and spirit of the present invention. Furthermore, by arbitrarily combining the plural components disclosed in the embodiments, various inventions can be realized. Furthermore, some components may be removed from all the components disclosed in the embodiments, while components of different embodiments may be arbitrarily combined.

What is claimed is:

1. An optical disk device, comprising:
a drawer to which a mechanical chassis is placed, the mechanical chassis having mounted thereto a drive mechanism for supporting and rotating a portable information recording medium, an optical pickup, a laser drive circuit for driving the optical pickup, a servo drive circuit, and an electronic circuit;
an antenna that is placed in the vicinity of an opening of a device main body at which the drawer is arranged;
a detection unit that detects an electric wave radiated from an outside radio equipment using the antenna; and
a control unit that, when the detection unit detects an electric wave of a frequency band that has a fear of bringing about malfunction, controls to prevent malfunction in the recording or reproduction operation for the portable information recording medium.

2. The optical disk device according to claim 1, wherein, when it is determined that the portable information recording medium is of record type medium, the control unit controls the laser drive circuit to temporarily suspend oscillation of laser from the optical pickup.

3. The optical disk device according to claim 1, wherein, when it is determined that the portable information recording medium is of read type medium, the control unit controls the laser drive circuit to temporarily enhance the output of oscillation of laser from the optical pickup to improve the S/N ratio.

4. The optical disk device according to claim 1, wherein the antenna is arranged at the inside or outside of a bezel that is arranged at the front surface of the drawer.

5. The optical disk device according to claim 1, wherein the antenna is embedded into the inside of a bezel that is arranged at the front surface of the drawer.

6. The optical disk device according to claim 1, wherein a flexible wiring of a lamp for displaying status arranged inside the opening is made to work as the antenna.

7. The optical disk device according to claim 1, wherein a wiring of an ejector button mounted to the surface of a bezel that is arranged at the front surface of the drawer is made to work as the antenna.

8. The optical disk device according to claim 1, wherein a static electricity lead-in tag of the device main body is made to work as the antenna.

9. The optical disk device according to claim 1, wherein the antenna is a rod antenna or a helical whip antenna.

10. The optical disk device according to claim 1, further comprising notification means for, when detecting an electric wave coming from outside, notifying the user of the detection.
